(19) United States
(12) Patent Application Publication
(10) Pub. No.: US 2019/0376559 A1
(43) Pub. Date: Dec. 12, 2019

(54) SLIDING COMPONENT, MATERIAL AND METHOD

(71) Applicants: Mahle Engine Systems UK Ltd, Rugby (GB); Mahle International GmbH, Stuttgart (DE)

(72) Inventors: Ian Laing, Rugby (GB); David Latham, Shrewsbury (GB)

(21) Appl. No.: 16/462,795

(22) PCT Filed: Nov. 9, 2017
(86) PCT No.: PCT/EP2017/078805

§ 371 Date: May 21, 2019

(30) Foreign Application Priority Data
Nov. 22, 2016 (GB) 1619705.5

(51) Int. Cl. F16C 33/20; F16C 33/04; F16C 9/02; F16C 17/02; C10M 103/02; C10M 171/06; C10M 107/44; C10M 107/28; C10M 107/34; C10M 107/38; C10M 111/04

(52) U.S. Cl. CPC F16C 33/201; C10N 2240/10; F16C 9/02; F16C 17/022; C10M 103/02; C10M 171/06; C10M 107/44; C10M 107/28; C10M 107/34; C10M 107/38; C10M 111/04; F16C 2208/02; F16C 2208/42; F16C 2240/64; F16C 33/206; C10M 2201/0413; C10M 2217/0443; C10M 2209/0806; C10M 2209/1033; C10M 2213/0606; C10N 2250/14; F16C 33/046

(57) ABSTRACT

A sliding component may include an overlay. The overlay may include graphene platelets functionalised with at least one of —O functional groups and —F functional groups within a matrix of at least one of a polymeric material and a plastics material.

### CROSS-REFERENCE TO RELATED APPLICATIONS

This application claims priority to International Patent Application No. PCT/EP2017/078805, filed on Nov. 9, 2017, and Great Britain Patent Application No. GB 1619705.5, filed on Nov. 22, 2016, the contents of both of which are hereby incorporated by reference in their entirety

### TECHNICAL FIELD

The present invention relates to sliding components having an overlay, or sliding layer, an overlay material and a method of forming the overlay. In particular the invention relates to sliding engine components for sliding bearing assemblies such as bearing shells, bushes, bearing surfaces of crankshafts, bearing surfaces of camshafts, bearing surfaces of connecting rods, thrust washers, flanges, bearing surfaces of a bearing block, bearing surfaces of a bearing cap, and piston assembly components such as piston rings, piston skirts, and cylinder walls and cylinder liners.

### BACKGROUND

In internal combustion engines, the main-bearing assemblies typically each comprise a pair of half bearings retaining a crankshaft that is rotatable about an axis. Each half bearing is a generally semi-cylindrical bearing shell, and typically at least one is a flanged half bearing provided with a semi-annular thrust washer extending outwardly (radially) at each axial end.

The bearing surfaces of bearing shells conventionally have a layered construction, in which a substrate comprising a strong backing material is coated with one or more layers having preferred tribological properties to provide a bearing surface that, in use, faces a cooperating moving part such as a crankshaft journal. In known bearing shells, the substrate comprises a backing coated with a lining layer, and the substrate is in turn coated with an overlay. The overlay is typically 6 to 25 μm thick and may be formed of a plastic polymer-based composite layer or a metal-alloy layer (e.g. a tin-based alloy overlay).

The function of the overlay is to provide a relatively soft, conformable layer that can accommodate any small misalignments between the harder steel crankshaft journal and the bearing shells, and receive and embed dirt particles that may circulate in the oil supply and enter the bearing, so as to prevent damage to or scoring of the journal. These functions of the overlay are respectively termed conformability and embedability.

It is generally known that wear of the overlay material can lead to exposure of the lining layer to which the overlay material is applied. This can lead to failure of the sliding component due to seizure.

Polymer-based overlays have become popular in recent years, and research into sliding components has resulted in a wide range of compositions of polymeric overlay materials. One particularly popular polymer base material is polyamide imide (PAI).

It is known to incorporate a variety of fillers, or additives, into the polymer matrices of overlays to alter their properties. Known fillers include materials such as: silane materials, which stabilise the polymer matrix; xylene; dry lubricant particles; and hard filler particles intended to enhance the wear resistance of the polymer matrix. The hard filler particles may, for example, be selected from the group consisting of: aluminium powder, aluminium flakes, SiC, WC, c-BN, and CaCO₃.

For example, WO2010066396 describes a plastic polymer-based composite material for use as an overlay on a copper- or aluminium-based lining layer, which is in turn bonded onto a steel backing. The described overlay comprises a matrix of a polyamide imide (PAI) polymer material, having distributed throughout the matrix (vol % proportions are specified with respect to the content of the overlay after the polymer has been cured): from 5 to less than 15 vol % of a metal powder and from 1 to 15 vol % of a fluoropolymer particulate. An exemplary layer of this type is of 12 μm thickness and comprises 12.5 vol % Al, 5.7 vol % PTFE particulate, 4.8 vol % silane, <0.1 vol % other components, and balance (approximately 77 vol %) polyamide imide resin, apart from incidental impurities.

The applicant's earlier patent application WO2016008770 describes a sliding component having a polymer-based overlay in which functionalised graphene nano-platelets are incorporated as filler particles in the polymer matrix. The functionalised graphene nano-platelets of WO2016008770 may be functionalised with —COOH and/or —NH₂ functional groups.

### SUMMARY

The invention provides a sliding component, an overlay material, a graphene-platelet filler material for an overlay material, a method of forming an overlay, and an engine comprising a sliding component, as defined in the appended independent claim(s) to which reference should now be made. Preferred or advantageous features of the invention are set out in dependent subclaim(s).

According to a first aspect of the present invention, there is provided a sliding component comprising an overlay, in which the overlay comprises: graphene platelets functionalised with —O and/or —F functional groups within a matrix of a polymeric or plastics material.

The graphene platelets may be termed, or may include, platelets, graphite platelets, graphene nano-platelets, or graphite nano-platelets.

During the applicant's previous research detailed in WO2016008770 it was found that functionalisation of graphene nano-platelets (GNPs) with —NH₂ and —COOH groups on the surface of the GNPs aided interaction with a polymer matrix to strengthen the matrix. The GNPs were functionalised by treatment with ammonia, to attach NH₃ groups to the platelets. As these groups bond covalently to the polymer matrix, they become NH₂ groups. This functionalisation described in WO2016008770 produced an improvement of roughly 20 MPa in the average seizure load of the overlay, compared to the same polymer overlay without the GNPs. These benefits were understood as being attributable to enhanced bonding between the —COOH groups on the GNPs and —NH₂ groups in the polymer matrix, and between the —NH₂ groups on the GNPs and —COOH groups in the polymer matrix. PAI was a preferred polymer that was found to be strengthened by the functionalised GNPs in this way.

The inventors in the present application have addressed the problem of improving the performance of a polymer overlay over the performance achieved by the —NH₂ or —COOH functionalisation described in WO2016008770. They have achieved this by selecting the —O and —F functionalisation of graphene platelets described in the present application.

The use of graphene platelets functionalised with —O and/or —F functional groups is counterintuitive, because it does not follow the approach taught in the prior art, such as in WO2016008770. In the prior art, the functionalising groups were selected to encourage bonding between the GNPs and the polymer matrix, with the goal of increasing the strength (and thus the wear resistance) of the overlay. In the present application, the inventors have followed a different approach, which is to use functionalising groups of small size, in order to increase dispersion of the platelets throughout the polymer matrix.

It would be expected that —O and —F functional groups would produce less of a reinforcing effect than that given by —COOH or NH₂ groups, because the —O and —F groups (unlike the —COOH and —NH₂ functional groups of the prior art) do not correspond to counterpart functional groups in the polymer matrix. However, to the inventors' surprise, the functionalisation of platelets with —O and/or —F functional groups produces a significant and unexpected improvement in the seizure performance of polymer overlays, compared to the overlays of WO2016008770.

The inventors' experiments have shown that the presence of —O and/or —F functionalised graphene platelets in embodiments of the present invention may both increase the seizure load of the overlay and improve the consistency of the overlay's performance. Additionally, overlays containing —O and/or —F functionalised graphene platelets may exhibit the improved seizure resistance over a large temperature range. Overlays embodying the present invention may thus advantageously improve seizure performance across the entire range of bearing temperatures that may be experienced during operation of an internal combustion engine.

The —O and/or —F functionalised platelets may be distributed throughout the whole of the overlay, or only a portion of the overlay. For example, the platelets may be distributed within one or more layers of a multiple-layer overlay. Preferably, however, the functionalised platelets are distributed uniformly within the polymeric matrix.

Graphene nano-platelets, like many very small particles, tend to aggregate together and may be difficult to disperse within the precursor, or deposition mixture, used to form a polymer overlay. The deposition mixture typically comprises components of the overlay diluted in a solvent, which can be for example sprayed onto a bearing surface and cured to form the overlay. If the graphene platelets aggregate with each other, then they cannot be dispersed effectively in the deposition mixture. The inventors have found that the —O and —F functionalisation significantly improves dispersion of the platelets, and leads to a more even distribution of the platelets in the polymer matrix of the overlay.

The bonding between individual platelets and the matrix may be expected to be disadvantageously weaker than for the —COOH and —NH₂ functionalised platelets described in WO2016008770. However, the inventors have found that achieving a more even distribution of the platelets through the volume of the overlay appears to be more important to overlay performance than bonding between the platelets and the polymer matrix.

Thus, platelets functionalised with —O and/or —F functional groups can be used to form overlays having properties which are greatly improved over those achieved in WO2016008770, as shown by the inventors' experimental results, below.

Being very thin, typically less than 50 nm, the functionalised platelets have a particularly high surface area (per unit mass) for interaction with the matrix. In use, it is found that the laminar shape of the functionalised platelets may provide enhanced resistance to the spreading of fractures through the composite layer. This effect is enhanced by the even distribution of —O and —F functionalised platelets throughout the overlay achieved in embodiments of the present invention. It is also preferable that the platelets are oriented parallel to the overlay surface. The improved dispersion of the —O and —F functionalised platelets may also improve this orientation of the platelets by comparison with the prior art.

The inventors have found that —O and —F functionalised platelets produce a highly significant improvement in overlay seizure resistance. As the platelets are so thin, a given weight percent (wt %) or volume percent (vol %) of —O and/or —F functionalised platelets provides a high number of platelets within the composite layer, providing an enhanced lubrication performance in the event of direct contact with the cooperating moving part, in use within a bearing assembly, as described below.

It has been found by the inventors that —O functional groups may advantageously provide particularly-enhanced seizure resistance. The functionalised platelets may comprise platelets that are functionalised with —O functional groups, that is, oxygen functional groups connected to the graphene platelets by a covalent bond. The inventors consider that this may be because the —O functional groups may reinforce the composite layer by hydrogen bonding to functional groups in the matrix of polymeric material (e.g. polyamide imide resin).

The inventors have further found that —F functional groups may advantageously provide particularly-enhanced seizure resistance. The functionalised platelets may comprise platelets that are functionalised with —F functional groups, that is, covalently-bonded fluorine functional groups. The inventors consider that this may be because the —F functional groups may improve seizure resistance by enhancing the lubrication properties of the overlay material.

Therefore, although enhanced performance may be obtained by functionalising platelets with either —O or —F functional groups, still better performance may be obtained by functionalising platelets with both —O and —F functional groups, to obtain synergistic effects of enhanced reinforcement of the overlay and enhanced low-friction, or lubricating, effects.

As shown in the detailed description, below, —COOH and —NH₂ functionalised GNPs have been found to provide a ˜20 MPa (˜17%) increase in seizure load compared to a PAI overlay containing no GNPs. The —O and —F functionalised GNPs of the present invention, however, have been found to generate a ˜40 MPa (˜33%) increase in seizure load compared to the same PAI overlay containing no GNPs.

Advantageously, the —O and/or —F functional groups on the functionalised platelets are small, and due to low steric hindrance they may provide enhanced surface interaction between the graphene platelets and the polymer matrix,

The presence of —O and/or —F functional groups may also allow the platelets to be effectively dispersed within the deposition mixture, which is deposited onto the substrate before being cured to form the overlay. The —O or —F functionalisation of the platelets may advantageously enhance the dispersion of the platelets within the deposition mixture, and therefore the overlay, due to electrostatic repulsion between the electronegative —O and/or —F functional groups on nearby platelets. This repulsion may reduce agglomeration and provide a more uniform dispersion of the platelets within the deposition mixture and within the deposited overlay compared to the overlays of the prior art containing —COOH and —NH₂ functionalised GNPs.

The inventors have also found that both —O and —F functionalised platelets may improve the reliability of polymer overlays, as the —O and —F functionalised overlays according to embodiments of the present invention exhibited highly consistent, repeatable, results under seizure testing. This consistency of performance is particularly important in achieving reliable performance of, for example, an engine comprising sliding bearings. During seizure testing, PAI overlays containing —O functionalised platelets showed a standard deviation that was approximately half of the standard deviation exhibited by a PAI containing no platelets, less than half of that exhibited by a PAI containing —NH₂ functionalised platelets, and less than one third of that exhibited by a PAI containing —COOH functionalised platelets. Under identical seizure testing, PAI overlays containing —F functionalised platelets showed a standard deviation that was less than half of the standard deviation exhibited by a PAI containing no platelets, approximately one third of that exhibited by a PAI containing —NH₂ functionalised platelets, and approximately one quarter of that exhibited by a PAI containing —COOH functionalised platelets. These smaller standard deviations indicate that overlays containing —O or —F functionalised platelets provide far more reliable and repeatable seizure performances than the overlays of the prior art. This improved consistency may be attributable to superior distribution of the platelets throughout the overlay.

The functionalised platelets may comprise platelets that are functionalised with both —O and —F functional groups. The —O and/or —F functionalised platelets may additionally, if desired, be functionalised with other groups such as —COOH or —NH₂ functional groups.

The functionalised platelets may typically comprise partially-functionalised platelets. These are platelets in which only a proportion of the active sites on the outer surface of each platelet are occupied by —O or —F functional groups. References in this document to functionalised platelets should be taken, as appropriate, to include partially-functionalised platelets.

The overlay of the sliding component may comprise between 0.01 and 4 wt % functionalised platelets. Preferably, the overlay may comprise at least 0.1, or 0.25, or 0.5, or 0.75, or 1 wt %, and less than or equal to 2, or 2.5, or 3, or 3.5 wt % functionalised platelets.

The functionalised platelets may have a maximal planar dimension of more than 1 μm and up to 10 μm, or 20 μm. Smaller planar dimensions may advantageously provide functionalised platelets with particularly-enhanced dispersion performance, being less susceptible to agglomeration within the polymer matrix. Larger planar dimensions may advantageously provide particularly enhanced strength in the polymer matrix.

The functionalised platelets may have a thickness of less than 50 nm.

Each functionalised graphene platelet may comprise a plurality of graphene layers. Preferably, the functionalised platelets comprise an average number of atomic layers of up to 20 layers.

The functionalised platelets may comprise an average of up to 4 layers. Advantageously, functionalised platelets having up to 4 layers provide the greatest enhancement in strength of the composite layer.

The functionalised platelets may comprise an average of at least 11 layers and up to 20 layers. Advantageously, functionalised platelets having at least 11 layers provide the greatest enhancement in the lubrication performance of the composite layer, in the event of direct contact with a cooperating moving part (e.g. a crankshaft journal).

The functionalised platelets may comprise an average of at least 5 and up to 10 layers. Functionalised platelets having 5 layers to 10 layers provide an advantageous balance between the enhancement in strength of the composite layer that is provided by functionalised platelets having only a small number of layers, and the enhancement in the lubrication performance of the composite layer, in the event of direct contact with a cooperating moving part (e.g. a crankshaft journal), that is provided by a greater number of layers.

An overlay embodying the first aspect of the invention may thus comprise functionalised platelets selected from platelets having an average of up to 4 layers; platelets having an average of at least 5 layers and up to 10 layers; and platelets having an average of at least 11 layers and up to 20 layers.

Preferably, the polymeric material comprises polyamide imide (PAI). Other suitable polymer bases include: polyimides; polyamides; epoxy; epoxy resins; phenolic or polybenzimidazole (PBI); acrylate resin; fluoropolymer or a combination of any of these materials. Such polymeric materials may advantageously provide high temperature, wear and chemical resistance.

Preferably, the total thickness of the overlay is between 3 μm and 25 μm. More preferably, the total thickness of the overlay is between 8 μm and 10 μm.

In addition to —O and/or —F functionalised platelets, the overlay may comprise known fillers.

According to a second aspect of the present invention, there is provided an overlay material comprising a matrix of polymeric material, and, within the matrix, platelets functionalised with —O and/or —F functional groups.

According to a third aspect of the present invention, there is provided a graphene platelet filler for an overlay material, the filler comprising platelets functionalised with —O and/or —F functional groups.

According to a fourth aspect of the present invention, there is provided a method of forming an overlay for a sliding component, comprising the steps of: mixing a polymeric material with platelets functionalised with —O and/or —F functional groups, to form a dispersion; and depositing the dispersion onto a substrate. The deposited dispersion may then be cured.

The overlay is preferably deposited onto the sliding component substrate as a deposition mixture. The deposition mixture of polymeric material and graphene platelets may further comprise a solvent, which may facilitate the formation of the deposition mixture. The solvent can be employed in various proportions in order to achieve a particular desired viscosity of mixture for coating onto the substrate. The deposition mixture may be a solution, a suspension or an emulsion or a mixture of any two or more of these forms.

According to a fifth aspect of the present invention, there is provided an engine comprising a sliding component according to the first aspect.

Features of the invention that are described in relation to the first aspect apply equally to corresponding features of the second, third, fourth and fifth aspects of the invention.

### BRIEF DESCRIPTION OF THE DRAWINGS

Specific embodiments of the invention will now be described by way of example, with reference to the accompanying drawings, in which:

FIG. 1A shows a three-quarter view of a semi-cylindrical bearing shell, which is an embodiment of a sliding component embodying the present invention;

FIG. 1B shows a cross-sectional view through part of the bearing shell of FIG. 1A.

### DETAILED DESCRIPTION

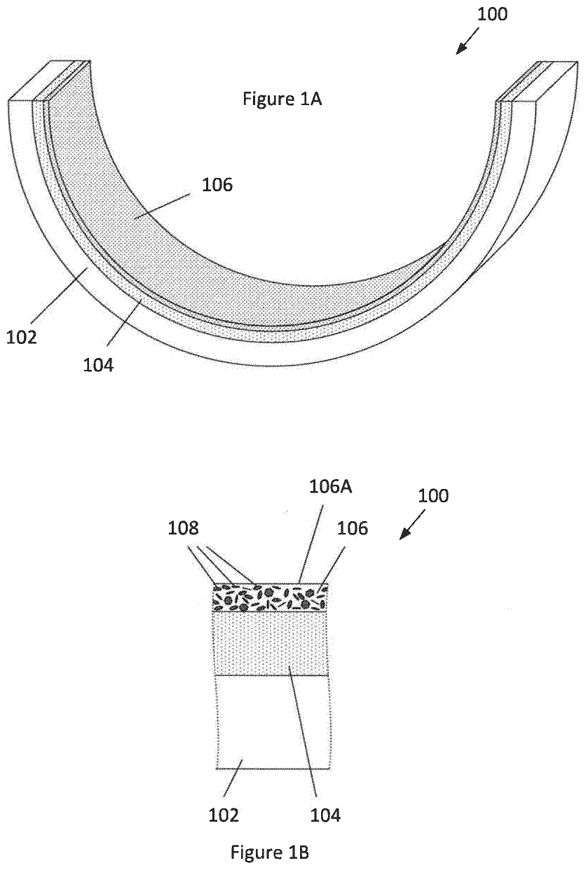

FIG. 1A schematically illustrates a semi-cylindrical bearing shell 100, which is also commonly referred to as a half bearing, for a main bearing assembly of an internal combustion engine for retaining a cylindrical journal of a crankshaft. FIG. 1B illustrates a cross-sectional view through a part of the bearing shell.

The bearing shell 100 has a layered construction incorporating a substrate comprising a steel backing 102 and a lining layer 104 comprising a layer of copper-tin bronze. An overlay 106 is formed by spray coating onto the lining layer of the substrate.

The backing 102 provides strength and resistance to deformation of the bearing shell 100, when it is assembled in a main-bearing housing.

The overlay 106 is configured to provide a running surface (or sliding surface) facing a cooperating moving part in a bearing assembly. In use, within an assembled bearing, the overlay 106 of the bearing shell 100 and a journaled shaft mutually cooperate, with an intervening film of lubricating oil (preferably providing hydrodynamic lubrication during normal running). The overlay 106 is particularly suited to accommodate small misalignments between the bearing surface and the shaft journal (conformability) and is able to receive and embed dirt particles circulating in the lubricating oil supply, so as to prevent scoring or damage to the journal surface by the debris (dirt embedability). The overlay 106 also provides suitable tribological properties between the bearing 100 and the shaft journal, if a failure of the intervening oil film should occur.

The overlay 106 comprises a matrix of polyamide imide (PAI) polymeric material, throughout which 2 wt % of —O (oxygen) functionalised graphene platelets 108 are distributed (wt % proportions are specified with respect to the content of the formed overlay, after it has been cured). The overlay 106 also comprises further filler materials (not illustrated) distributed throughout the matrix of the plastic polymer material, as is known in the art.

The functionalised platelets 108 are small sheets of graphene having an average number of atomic layers from 1 to approximately 20 atomic layers. The functionalised platelets have a particularly-high surface area for bonding to the matrix material, and thereby reinforcing the composite overlay.

The platelets have an average thickness of less than 50 nm.

The platelets have a maximal planar dimension (i.e. the largest dimension in the plane of the platelet) of 10 μm, which advantageously provides particularly enhanced strength in the composite overlay.

The functionalised platelets 108 are partially functionalised with —O functional groups (i.e. only a proportion of the active sites on the outer surface of each platelet are occupied by an oxygen functional group). Advantageously, partial functionalisation provides good platelet dispersion, whilst also providing good bonding performance to the matrix material.

The use of —O functionalised platelets provides significant advantages, including the following. The addition of —O functionalised platelets advantageously enhances the seizure performance of the overlay compared to known overlays comprising —COOH and/or NH₂ functionalised platelets. The —O functionalised platelets provide improved seizure performance, by providing an enhanced lubrication function, if exposed at the bearing surface. Exposed —O functionalised platelets, at the bearing surface, increase lubricious properties of the free surface, reducing friction of the overlay. This is important in the event that the journaled shaft contacts the bearing surface, for example when the bearing is not fully supplied with lubrication oil, which can occur when an engine starts and before the lubrication oil has risen to working pressure. Overlays containing —O functionalised platelets may also advantageously achieve more consistent seizure performance than that demonstrated by the prior art.

The —O functionalised platelets may also strengthen the polymer matrix by hydrogen bonding to functional groups in the PAI matrix. Further, the functionalised platelets may enhance the thermal conductivity of the composite layer, enabling enhanced thermal dissipation through the composite layer. Yet further, the functionalised platelets may improve fatigue performance, obstructing propagation of fractures in the composite overlay, and may reduce material wear of the overlay.

In particular, the inventors have found that the plastic polymer-based composite layer comprising —O functionalised platelets may achieve enhanced fatigue resistance and wear resistance compared with the —COOH or —NH₂ functionalised graphene overlays of WO2016008770, whilst still permitting good embedability of any particulate carried in the oil that lubricates the bearing, in use.

Specifically, tests of overlays containing —O functionalised platelets achieved an average reduction of 19% in the quantity of material removed from the overlay by wear, and produced a statistically very-significant improvement over the prior-art overlays. Overlays containing —F functionalised platelets achieved a smaller reduction in wear of 5%.

The platelet may alternatively, or in addition, be functionalised with —F (fluorine) functional groups. The inventors have found that the use of —F functionalised platelets may provide significant advantages over the prior art, similar to those described above in relation to —O functionalised platelets.

As shown in the experimental results discussed below, —F functionalised platelets achieve greatly-improved seizure performance compared to the prior art. In particular, while —COOH and —NH₂ functionalised platelets have been found to provide a ˜20 MPa (˜17%) increase in seizure load compared to a platelet-free PAI overlay, —O and —F functionalised platelets have been found to generate a ˜40 MPa (˜33%) increase in seizure load.

The —F functionalised platelets may advantageously inhibit seizure of the sliding component by providing an enhanced lubrication function, if —F functionalised platelets are exposed at the bearing surface. In the same way as described above in relation to —O functionalised platelets, —F functional groups may also have the advantageous effect of strengthening the polymer matrix. Overlays containing —F functionalised platelets may particularly advantageously achieve more consistent seizure performance than that demonstrated by the prior art.

### Seizure Resistance

The improved performance of embodiments of the invention has been demonstrated by seizure testing. These tests were carried out using a test rig in which a constantly-increasing lateral (downward) load is applied to steel journal rotating within a test bearing. Lubrication is applied to the test bearing but a groove in the journal prevents hydrodynamic running, in order to enable an accelerated test under challenging lubrication conditions. The torque required to rotate the journal is measured, and the temperature of the bearing is measured. A test continues until either a maximum lateral load (of 200 MPa) is applied to the bearing, or the bearing fails (seizes) because the measured torque exceeds a predetermined maximum torque, or because the measured temperature exceeds a predetermined maximum temperature. If either the threshold (cut-off) value of torque or temperature is reached, the test is automatically stopped. This seizure test provides a repeatable set of accelerated-wear conditions for comparing different overlays. To ensure statistical robustness at least six of each type of bearing is tested.

The seizure test measures the average seizure load (Mpa) at which the overlay seizes, as well as the failure mode, i.e. whether the seizure was due to an increase in the measured torque or temperature.

Five types of bearings were tested under the same conditions, termed bearings A to E.

Bearing A was a bearing having a PAI-based overlay according to the prior art, in which the overlay contained no functionalised graphene platelets.

The overlays of Bearings B to E comprised graphene platelets at 2 wt % of the PAI overlay, so that Bearings B to E differed only according to the functional groups used in the platelets of their overlays.

In Bearing B the graphene platelets were functionalised with —NH₂ functional groups as described in WO2016008770.

In Bearing C the graphene platelets were functionalised with —COOH functional groups as described in WO2016008770.

In Bearing D the graphene platelets were functionalised with —O functional groups.

In Bearing E the graphene platelets were functionalised with —F functional groups.

Six samples of each of the bearings were tested under the same seizure-test conditions and the following results were obtained:

Bearing A exhibited an average seizure load (downward load applied to the test journal just before bearing seizure) of 116.5 Mpa with a standard deviation of 12 MPa;

Bearing B exhibited an average seizure load of 142 MPa with a standard deviation of 14 MPa;

Bearing C exhibited an average seizure load of 142 MPa with a standard deviation of 20 MPa;

Bearing D exhibited an average seizure load of 160 MPa with a standard deviation of 6 MPa; and

Bearing E exhibited an average seizure load of 155 MPa with a standard deviation of 5 Mpa.

Analysis of the seizure modes of Bearings A to E also showed that:

Bearing A failed due to an increase in measured torque beyond a predetermined torque failure threshold (bearing seizure) in each of the six tests;

Bearing B failed due to an increase in measured torque beyond a predetermined torque failure threshold (bearing seizure) in each of the six tests;

Bearing C failed due to an increase in measured torque beyond a predetermined torque failure threshold (bearing seizure) in four of the six tests, and in the other two tests reached the upper temperature limit of the test (200° C.) without seizing;

Bearing D failed due to an increase in measured torque beyond a predetermined torque failure threshold (bearing seizure) in two of the six tests and in the other four tests reached the upper temperature limit of the test (200° C.) without seizing; and

Bearing E reached the upper temperature limit of the test (200° C.) without seizing in each of the six tests.

The scuff rating of the bearings was also tested. The scuff rating determines seizure performance by analysing recovery events experienced by the bearings before failure. As the load on the bearing is increased, miniature seizure events can occur, from which a bearing may be able to recover. A recovery event may occur where low melting point constituents in the overlay melt and allow the bearing friction to reduce so that the bearing continues to function without fully seizing. These recovery events can be characterised by a rise in overlay temperature followed by a drop back down again. The scuff rating of an overlay is measured as the average number of recovery events that the overlay can experience before failure.

Traditional metallic bearing overlays typically demonstrate multiple recovery events, and so achieve relatively high scuff ratings (such as 3 to 5 scuffing events before failure for bimetal or leaded electroplated bearings). Conventional polymer overlays, however, tend to seize without demonstrating these recovery events.

Scuff ratings of more than zero may be desirable as a recovery event may serve as a warning prior to final seizure of the bearing. This may advantageously allow the engine to be safely shut down in advance of catastrophic failure.

The scuff ratings of six samples of each of Bearings A to E were measured and the following results were obtained:

Bearing A exhibited a scuff rating (average number of recovery events before failure due to an increase in measured torque beyond a predetermined torque failure threshold) of 0.5;

Bearing B exhibited a scuff rating of 0.5;

Bearing C exhibited a scuff rating of 1.5;

Bearing D exhibited a scuff rating of 1; and

Bearing E exhibited a scuff rating of 2.2.

Both —O and —F functionalised platelets therefore significantly enhanced the scuff rating compared to a PAI overlay containing no graphene platelets. Of all the overlays tested, overlays containing —F functionalised platelets (Bearing E) provided by far the highest scuff rating. Fluorine functionalised platelets may therefore be particularly advantageous for increasing the scuff rating of polymer overlays so as to allow the engine containing the overlay to be safely shut down in advance of catastrophic failure.

Of the five bearing types tested, the overlays embodying the present invention comprising —O and —F functionalised platelets produced the highest average final seizure loads and the tightest spreads of seizure loads (lowest standard deviation). Additionally, —O and —F functionalised GNP overlays reached the temperature limit of the test rather than seizing in the majority of cases. The test is stopped when the bearings reach 200° C., as this is well beyond the operational temperature range of a main bearing of an internal combustion engine. For example, the standard material of Bearing A seized on all six tests whereas all six overlays comprising —F functionalised GNPs reached the temperature cut-off of the test without seizing.

Overall, —COOH and —NH₂ functionalised platelets have been found to provide a ˜20 MPa (˜17%) increase in seizure load, while the —O and —F functionalised platelets of the present invention generate a ˜40 MPa (—33%) increase in seizure load.

### Forming an Overlay

Prior to functionalisation, graphene platelets comprise one or more one-atom-thick planar layers of carbon atoms. Each carbon atom is sp² hybridised and forms a bond with each of three neighbouring carbon atoms in a trigonal planar configuration. Once functionalised a layer typically becomes non-planar (e.g. with periodically-distributed functional groups, a layer may become puckered or corrugated), particularly in those regions of the layer to which the functionalisation is attached. Typically, any carbon atom in the lattice which is functionalised will be sp³ hybridised, forming a bond with each of three neighbouring carbon atoms and one further bond to the functional group (e.g. to the —O or —F group), and thus adopts a non-planar tetrahedral configuration.

The functionalised graphene platelets may be formed by plasma functionalisation, in which active sites on the planar surface and/or edges of the platelets are populated with functional groups, providing complete or partial saturation of the available active sites on the outside of the platelets.

Overlays embodying the invention may conveniently be made using techniques that are described in the prior art for forming overlays comprising fillers in polymer matrices. Such techniques are well known to the skilled person, but exemplary comments are set out below for completeness.

The overlay 106 is formed by depositing a deposition mixture comprising the polymeric PAI material dissolved in a solvent, in which the —O and/or —F functionalised platelets (and any other desired overlay fillers or particulates) are suspended. In the illustrated examples, the solvent comprises N-ethyl-2-pyrrolidone (NEP) and/or N-methyl-2-pyrrolidone (NMP), a small proportion of xylene solvent, and water. The solvent system can be employed in various proportions, relative to the plastic polymer and functionalised platelets (and any other suspended solid particulate) in order to achieve a particular desired viscosity of the deposition mixture for coating onto the substrate. Prior to deposition, the functionalised platelets (and any other suspended solid particulate) are preferably maintained in suspension by agitation of the deposition mixture. The solvent system facilitates forming and depositing the mixture, and the proportion of solvent to polymer (and any particulate) in the mixture is chosen to optimise deposition performance.

The —O and/or —F functionalisation of the platelets may advantageously enhance the dispersion of the platelets within the deposition mixture, prior to deposition of the polymeric material, by repelling the —O and/or —F functional groups on nearby platelets, and therefore reducing attraction between the platelets. This reduces agglomeration and promotes more uniform dispersion of the platelets within the deposited overlay.

The overlay may be deposited onto the substrate by a spray coating, from a spray gun. Alternatively, the overlay may be deposited by screen printing (i.e. through a mask), by a pad-printing process (i.e. an indirect offset-printing process, e.g. in which a silicone pad transfers a patterned layer of the plastic polymer composite material onto the sliding-bearing substrate), or by a transfer rolling process.

Although the overlay may be deposited in a single deposition step, for greater thicknesses the overlay may be built up by deposition of a succession of sub-layers, with a flash-off stage provided between successive depositions to remove solvent from the sub-layers.

Curing the deposited overlay induces molecular cross-linking of molecules in the plastic polymer. Curing also removes substantially all solvent from the overlay, including any residual solvent from flashed-off sub-layers.

The cured overlay 106 may have a thickness of 3 to 14 μm, with thicker layers being formed from a succession of sub-layers. For example, an overlay 106 of 8 to 12 μm thickness may be built up by the deposition of two or three sub-layers.

Although described herein and illustrated in the drawings in relation to a half bearing shell, the present invention may equally apply to other sliding engine components, including semi-annular, annular or circular thrust washers, and bushes, and engines comprising such sliding engine components.

1. A sliding component comprising an overlay including graphene platelets functionalised with at least one of —O functional groups and —F functional groups within a matrix of at least one of a polymeric material and a plastics material.

2. The sliding component according to claim 1, wherein the functionalised graphene platelets includes partially-functionalised graphene platelets.

3. The sliding component according to claim 1, wherein the overlay includes 0.01 wt % to 4 wt % functionalised graphene platelets.

4. The sliding component according to claim 3, wherein the overlay includes 0.1 wt % to 2 wt % functionalised graphene platelets.

5. The sliding component according to claim 1, wherein the functionalised graphene platelets have a maximal planar dimension of 20 μm or less.

6. The sliding component according to claim 5, wherein the functionalised graphene platelets have a thickness of less than 50 nm.

7. The sliding component according to claim 1, wherein each platelet of the functionalised graphene platelets has layers, and the functionalised graphene platelets have an average of 20 layers per platelet or less.

8. The sliding component according to claim 1, wherein each platelet of the functionalised graphene platelets has layers, and the functionalised graphene platelets have an average of 4 layers per platelet or less.

9. The sliding component according to claim 1, wherein each platelet of the functionalised graphene platelets has layers, and the functionalised graphene platelets have an average of 5 to 10 layers per platelet.

10. The sliding component according to claim 1, wherein each platelet of the functionalised graphene platelets has layers, and the functionalised graphene platelets have an average of at least 11 layers per platelet.

11. The sliding component according to claim 1, wherein the at least one of the polymeric material and the plastics material includes the polymeric material, and wherein the polymeric material is one of a polyamide imide resin, an acrylate resin, an epoxy resin, a fluoropolymer, and a polybenzimidazole.

12. An overlay material comprising a matrix of polymeric material, and, within the matrix, graphene platelets functionalised with at least one of —O functional groups and —F functional groups.

13. A graphene platelet filler for an overlay material, comprising graphene platelets functionalised with at least one of —O functional groups and —F functional groups.

14. A method of forming an overlay for a sliding component, comprising:
forming a dispersion via mixing a polymeric material with graphene platelets functionalised with at least one of —O functional groups and —F functional groups; and
depositing the dispersion onto a substrate.

15. An engine comprising a sliding component including an overlay having a matrix of at least one of a polymeric material and a plastics material, the overlay including functionalised graphene platelets dispersed within the matrix, wherein the functionalised graphene platelets are functionalised with at least one of —O functional groups and —F functional groups.

16. The sliding component according to claim 1, wherein:
the functionalised graphene platelets functionalised with the —O functional groups are graphene platelets covalently bonded with at least one oxygen functional group; and
the functionalised graphene platelets functionalised with the —F functional groups are graphene platelets covalently bonded with at least one fluorine functional group.

17. The sliding component according to claim 16, wherein the functionalised graphene platelets includes a subset of graphene platelets functionalised with both —O functional groups and —F functional groups.

18. The sliding component according to claim 1, wherein the functionalised graphene platelets have a laminar shape oriented substantially parallel to a sliding surface of the overlay and are dispersed throughout the matrix substantially evenly.

19. The sliding component according to claim 1, wherein the overlay is a multi-layer overlay including at least one first layer and at least one second layer, and wherein the functionalised graphene platelets are dispersed only within the at least one first layer.

20. The sliding component according to claim 2, wherein each platelet of the functionalised graphene platelets includes an average of 1 to 20 atomic graphene layers.
